(19) United States
(12) Patent Application Publication
(10) Pub. No.: US 2002/0103882 A1
(43) Pub. Date: Aug. 1, 2002

(54) Method and system for hands-on e-learning

(76) Inventors: Robin Andrew Courtland Johnston, Hertfordshire (GB); John McDermott, Eagle Nest, NM (US); David O'Neal, Dumfries, VA (US)

Correspondence Address: MCDERMOTT WILL & EMERY, 600 13TH STREET, N.W., WASHINGTON, DC, 20005-3096, US

(21) Appl. No.: 09/968,716

(22) Filed: Oct. 2, 2001

Related U.S. Application Data
(60) Provisional application No. 60/236,729, filed on Oct. 2, 2000.
(60) Provisional application No. 60/309,774, filed on Aug. 6, 2001.

(51) Int. Cl. G06F 15/16

(52) U.S. Cl. 709/218; 709/203

(57) ABSTRACT

A remotely training system provides instruction to one or more users at the same or different times in an interactive manner that provides actual responses to the actual user inputs during instruction. Within the system, the user computer and additional networked computers typically cannot be crashed by the user inputs. Further, the present invention can provide online interactive instruction with high response speeds that substantially match speeds that would occur if a single user were providing instructions to computers, which they alone were accessing. A user accesses a remote system which has multiple virtual machines arranged to form a virtual network. Within this virtual environment, a user can reconfigure software and operating system settings as well as test software applications without being required to have the software and hardware resources locally available and without fear of damaging the remote system.

### RELATED APPLICATIONS

This application relates to and claims priority from U.S. Provisional Application Ser. No. 60/236,729 filed Oct. 2, 2000 entitled E-LEARNING HANDS-ON and U.S. Provisional Application Ser. No. 60/309,774 filed Aug. 6, 2001 entitled METHOD AND SYSTEM FOR HANDS-ON E-LEARNING, the disclosures of which are hereby incorporated in its entirety by reference.

### FIELD OF THE INVENTION

The present invention relates to distributed computing environments and more particularly, to such environments including virtual machines.

### BACKGROUND OF THE INVENTION

Many technical training companies have some form of Computer Based Training (CBT). In a typical example of such training, training materials are formatted onto a CD ROM. Current CBT has several drawbacks. One particular drawback is the way in which students interact with PC-based operating systems and their applications.

Networked computers, including intranets and the global network commonly referred to as the Internet, provide a tool by which computer-based instruction can be provided to one or more individual users at the same or different times, and with the users at the same or different locations. In such systems, the user is located at a user computer through which the user accesses instructional computer software that resides on a different computer networked to the user computer. As an example, such a system and method can be particularly useful for providing instruction regarding the various aspects of computer operations.

Currently, on-line instruction is performed in various formats. These include pre-recorded video with or without uncoordinated or coordinated pre-recorded text, which are typically not interactive. Other formats attempt to include an interactive aspect. One such format sometimes referred to as “navigated screen shots,” includes prompting a user to provide an input to the system, to which the system then responds. In such a system, if the user provides the predetermined given input, the system displays a pre-recorded image (i.e., screen shot) of how the display would appear if the user were to provide the same predetermined given input to an actual computer system. Unfortunately, if the user provides an input different from the predetermined given input, the system will typically either display the same image as if the predetermined given input was provided, or returns and error message to the user. In the former instance, the user may likely be unaware that the provided input was incorrect, which likely is not supportive of the user learning the instruction material. In the latter instance, the user only knows tat the provided input was incorrect, but still is not assisted in determining what the expected (i.e., correct) user input is. Also, such “navigated screen shot” systems are typically expensive and time consuming to develop and maintain, given the number of screen shots that must be produced and stored.

Another technique that can be used to convey the steps of an exercise is recording a screen capture video of an expert performing the exercise and dictating the steps as they go. This demonstration method does not allow the students to have meaningful or substantive interaction with the system.

Neither of these solutions just described allow students to participate on a live computer (where the systems behavior is real rather than a scripted presentation as previously described) unless the students have installed software locally on their own computer system. Such installation and use has the disadvantage of potentially interfering with their current system configurations and using up local machine resources. Currently for students to practice or experiment with knowledge gained on a course, be it CBT or via the Internet, they must have access to several machines that they can afford to re-configure at will. Thus, cost and space constraints can limit the number of users who can benefit from having a test system to experiment with. Further to this, it can take considerable time to load and configure a group of PCs to provide a suitable environment that would be a useful learning environment.

### SUMMARY OF THE INVENTION

The present invention addresses the shortcomings of the prior art by providing the capability of giving students live computers to use via the Internet or other network for the purpose of conducting remote training exercises or training modules. Hence, the present systems and methods provide instruction to one or more users at the same or different times in an interactive manner that provides actual responses to the actual user inputs during instruction. These systems and methods also provide such instruction such that regardless of the instructional computer software and the user inputs, the user computer and additional networked computers typically cannot be crashed by the user inputs. Furthermore, all these features are supplied on demand instead of needing to be pre-scheduled.

One aspect of the present invention relates to a method for providing remote access to a software application. According to this aspect, in response to an instruction received at a host computer to communicate with a client computer, the host computer initiates a plurality of virtual machines and receives input from the client computer destined for a particular virtual machine. That virtual machine executes a software application in accordance with the input and provides to the client computer the results from that execution.

Another aspect of the present invention relates to a method for controlling the access to a plurality of host systems. According to this aspect, a request is received from a client to access one of the host systems and it is determined whether one of the hosts is available to handle the requests. If a particular host is available, then that host is instructed to initiate a plurality of virtual machines and the host's identity is transmitted to the client.

A further aspect of the present invention relates to a system that provides remote access. In accordance with this aspect, a first computer is configured to identify one of a host of available systems based on a request from a client computer. The identified host is configured to receive an instruction to initiate a plurality of virtual machines, to receive data destined for one of the virtual machines and to operate the virtual machines in accordance with the data.

### BRIEF DESCRIPTION OF THE DRAWINGS

The present invention is illustrated by way of example and not by way of limitation, in the figures of the accompanying drawings and in which like reference numeral refer to similar elements and in which:

FIG. 1 illustrates an exemplary hardware platform for certain aspects of various embodiments of the present invention.

FIG. 2 illustrates an exemplary networked environment for embodiments of the present invention.

FIG. 3 illustrates an exemplary Dynamic Learning Unit (DLU) in accordance with an embodiment of the present invention.

FIG. 4 depicts a flowchart illustrating an operating method in accordance with an embodiment of the present invention.

FIG. 5 illustrates an exemplary browser interface in accordance with an embodiment of the present invention.

FIG. 6 illustrates an exemplary Dynamic Learning Manager (DLM) database in accordance with an embodiment of the present invention.

### DETAILED DESCRIPTION

In the following description, for purposes of explanation, numerous specific details are set forth in order to provide a thorough understanding of the present invention. It will be apparent, however, to one schooled in the art that the present invention may be practiced without these specific details. In other instances, well known structures and devices are shown in block diagram form in order to avoid unnecessarily obscuring the present invention.

### Exemplary Hardware

The description of the invention that follows is exemplary. However, it should be clearly understood that the present invention may be practiced without the specific details described herein. Well known structures and devices are shown in block diagram form in order to avoid unnecessarily obscuring the present invention.

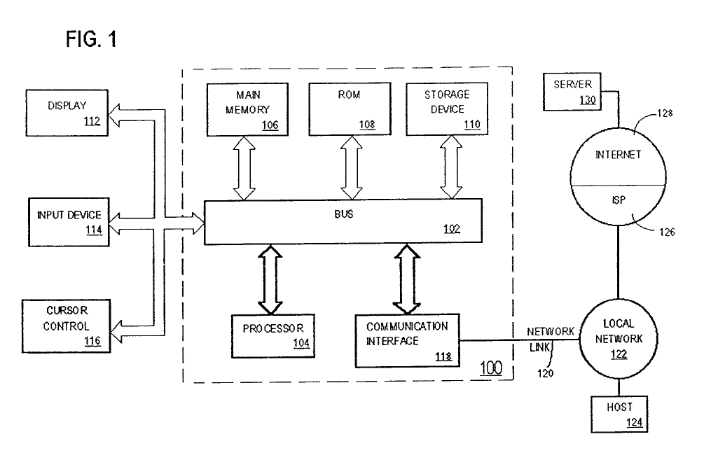

At least portions of the invention are intended to be implemented on or over a local computer network or a more distributed network such as the Internet. An example of such a network is described in FIG. 1, attached.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, such as a keyboard, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem attached to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information. Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

### Exemplary Environment

Embodiments of the present inventive system allow students to interact with live machines via the Internet or other network. By “live machines”, it is meant that when users connect through the system's web site they can control a virtual network of computers rather than merely receive a pre-recorded series of screen shots.

An exemplary embodiment of the present invention includes a remote network environment in which an user, for example a student, can control a group of PCs, the PC operating systems and applications for the specific purpose of learning, testing, etc. While an exemplary embodiment is discussed herein in the particular context of training, the present invention also applies to environments such as testing, sales demonstrations, user pre-purchase evaluations, desktop service provision, pre-configured systems on demand, with suitable modification to the exemplary embodiments described herein.

The present invention includes systems and methods in which machines can be supplied on an on-demand basis for specific training objectives. In an educational scenario, this objective might be a particular training environment relevant to the training needs of students. Research has shown that students greatly value participating and working on a live computer network. They see in real life how mistakes can be made and the consequences of such mistakes. Some of the resulting benefits include students experiencing real results of their actions and the ability to interact with other servers and workstations on the network. One method of certain embodiments of the present invention facilitates a student accessing a series of computers using his or her own computer and the Internet or other network as a medium. The student can interact with a virtual environment provided by the present invention, where the student can experience a network of computers available to configure and test as required or desired. Another method of other embodiments of the present invention can facilitate the reinforcement of learning objectives contained in materials presented in other formats, e.g., as part of a complete computer-training package on the Internet or other network.

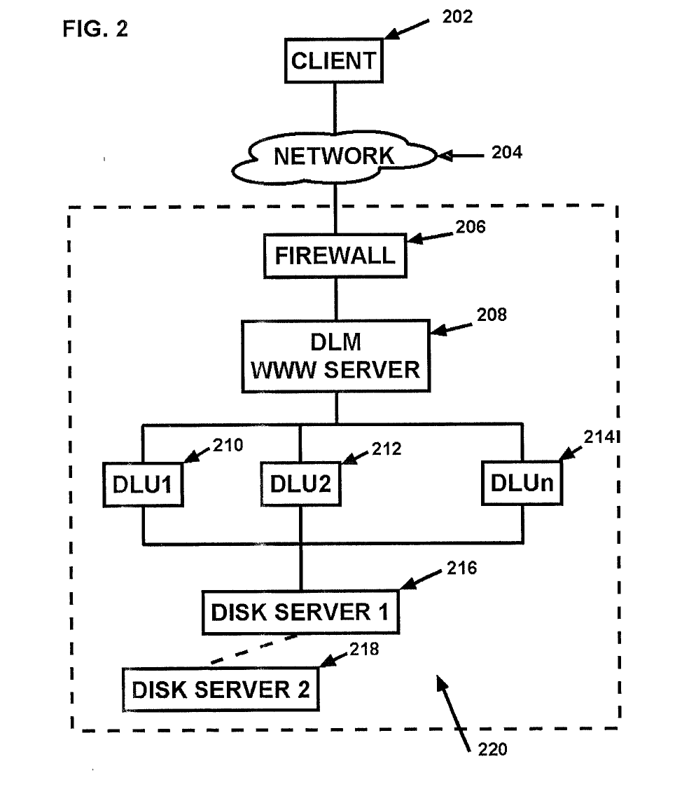

FIG. 2 depicts an exemplary network for one embodiment of the present invention. A client 202 is shown in FIG. 2 who utilizes the Internet 204 for example to access the training network 220. While only one client 202 is depicted, multiple clients, or users, can simultaneously access the training network 220. The client 202 uses typical Internet connection methods such as a web browser to connect to the Internet 204. The terms “client” and “user” are used interchangeably to refer to either the student using the training network 220 or the client machine 202 accessing the training network 220. In addition to the exemplary network of FIG. 2, the present invention contemplates a more private network arrangement in which a local area network or proprietary network is used instead of the Internet 204.

An optional firewall 206 is illustrated which limits accessibility to the training network 220. The functionality of the firewall 206 can be embodied on a stand alone system or integrated into the server 208 if desired.

The Dynamic Learning Manager (DLM) 208 is connected to the firewall 206 and controls the client access to the Dynamic Learning Units (DLU) 210-214. The DLM is connected to the DLUs 210-214 via a network 222.

Each of the DLUs 210-214 provide virtual environments used by a client 202. In a preferred embodiment, each DLU can facilitate the connection of one student at any moment in time.

A web server 208 is also depicted in FIG. 2 that receives requests from a client 202 and allocates DLU resources to perform each request. This server 208 does not need to be located on the same machine as the DLM 208 (as shown in FIG. 2) as long as the web server can communicate over the Internet or other network with the DLM.

Disk servers 216 and 218 are one or more systems that can communicate with the DLUs 210-214 to provide reliable data storage, as more fully described herein.

The individual machines and functions depicted in FIG. 2 can be provided in redundant fashion, as is conventional in the art, in order to improve reliability, increase performance, and provide fail over operation.

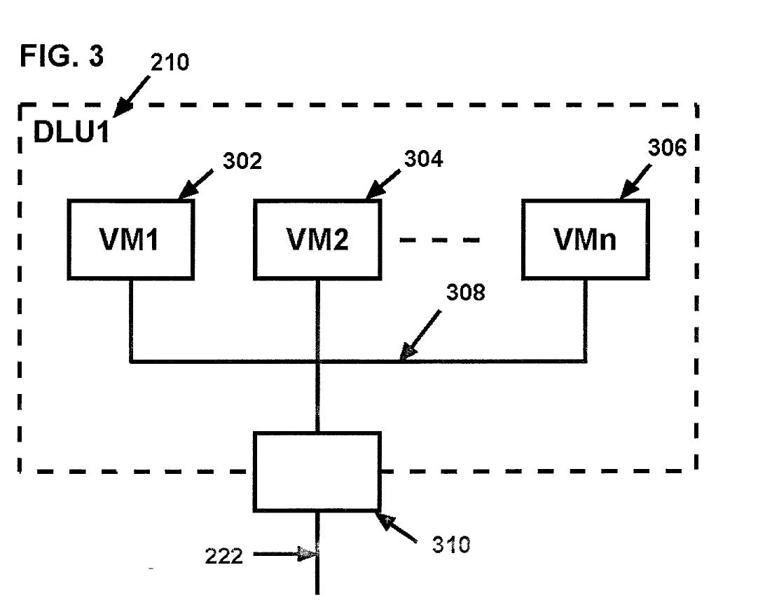

FIG. 3 illustrates an individual DLU 210 that provides the virtual environment used by a client 202. In particular, a plurality of virtual machines 302-306 execute on the DLU 210 forming a virtual network 308 accessible by the client 202. The virtual network 308, and thus the virtual machines 302-306, communicates with the external network 222 via a physical network port 310 on the DLU 210.

### Exemplary Operation

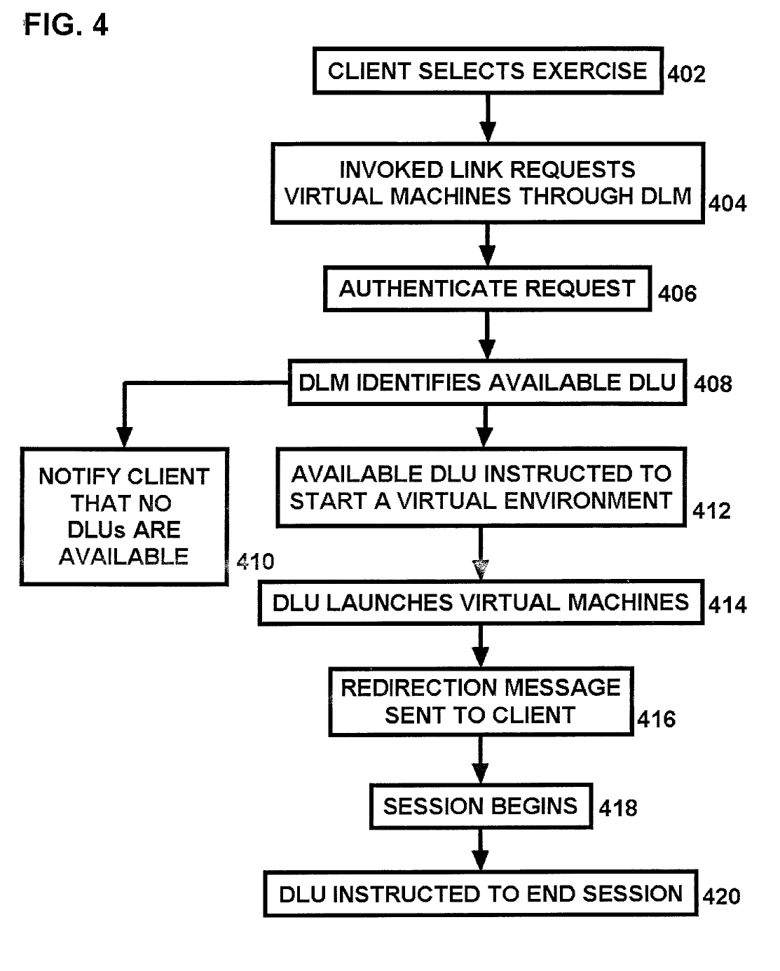

FIG. 4 illustrates a flowchart for one embodiment of the present invention. In step 402, a client (or student) 202 connects to the web server 208 and selects an exercise to perform, In particular, the web server 208 can serve an HTML page identifying a variety of exercises or software environments for access by the client 202. In one embodiment, the server has a login feature which permits the client 202 to be identified so that a dynamically generated HTML page can be displayed which is personalized for the particular client.

The web server 208 can be part of the training network 220 or a signal in the form of a secure redirection could originate from an remote web server hosting other learning or related materials. In other words, the web server 208 does not need to be under the direct control of the training network 220; instead, it can provide secure links to a third party to control access to the training network 220.

In step 404, as a result of the clients selection from the provided HTML page, the invoked link requests a virtual environment from the DLM 208.

Step 406 is a optional step in which the DLM 208 can authenticate the user request against an access control list, or similar means, maintained by a locally or remotely connected machine. If the user's request is not authenticated, then the request is blocked and, preferably, an appropriate status message is returned to the user. Once authenticated, however, functioning of the system continues with step 408.

The DLM 208 maintains a list of available DLUs 210-214 along with their individual capabilities such as memory, CPU speed and type, number of CPUs, etc. This list can be updated in response to update requests from the DLM 208 to the DLUs 210-214 or periodically (e.g., heartbeat function). The DLM 208, in step 408 identifies an appropriate DLU from among the available DLUs 210-214 to service the request from the web server. If there are no DLU machines available to service the request, then the DLM 208, in step 410, tells the web server which sends a message to the client 202 that the system is at capacity and to try again later.

If there is an available DLU, the DLM 208 selects, in step 412, that DLU to serve the request and tells the DLU to start the virtual machines appropriate for the selected exercise.

In step 414, the selected DLU receives the instruction from the DLM 208 and proceeds to launch one or more virtual machines according to the parameters passed to the DLU from the DLM. Preferably, these virtual machine images exist on one or more disk servers 216-218 in a read-only format. This particular arrangement is beneficial in that any changes a student makes to a virtual machine is stored locally on the DLU during the training session but are discarded when the session is over.

In a preferred embodiment, the sending and acknowledging of instructions between the DLM 208 and the selected DLU can be timed in order to prevent unnecessary waiting. For example, when the DLM 208 instructs the DLU to launch the virtual machines, the DLM can start a timer. If the DLU does not acknowledge the completion of launching the virtual machines before the timer expires, then the DLM can contact alternate DLUs, log an error message, notify the user to wait longer, or any combination of these options.

In step 416, the client 202 is informed that the virtual environment for the selected exercise is ready. In one embodiment, the web server 208 waits a predefined delay period and sends a redirection message to the client 202 informing the client 202 browser to redirect to the appropriate DLU which has (by now) launched the requested virtual environment. In other embodiments, a pre-defined delay period is not used but, rather, the DLU informs the web server to notify the client 202 that the requested virtual environment is ready.

Instead of the client 202 being redirected to the DLU which was selected to provide the virtual environment, the client can alternatively be redirected to the DLM 208. In this latter embodiment, another layer of management and redirection is provided by the DLM 208 which becomes responsible for receiving communications from all clients 202 for all the different virtual machines and redirecting these communications to the right virtual machine on the right DLU. Port redirection can be accomplished on either the DLU, the DLM or both, by a number of conventional means, for example. One such port redirection for TCP/IP networks is called redir and allows one IP address or physical network connections (e.g. 310) to receive communication packets destined for multiple virtual connections (e.g. 302-306) and multiplex the packets to the appropriate virtual connection.

After the client 202 receives the redirection instructions, the client 202 is connected to the virtual machines in the virtual environment on the DLU and can start the training session in step 418.

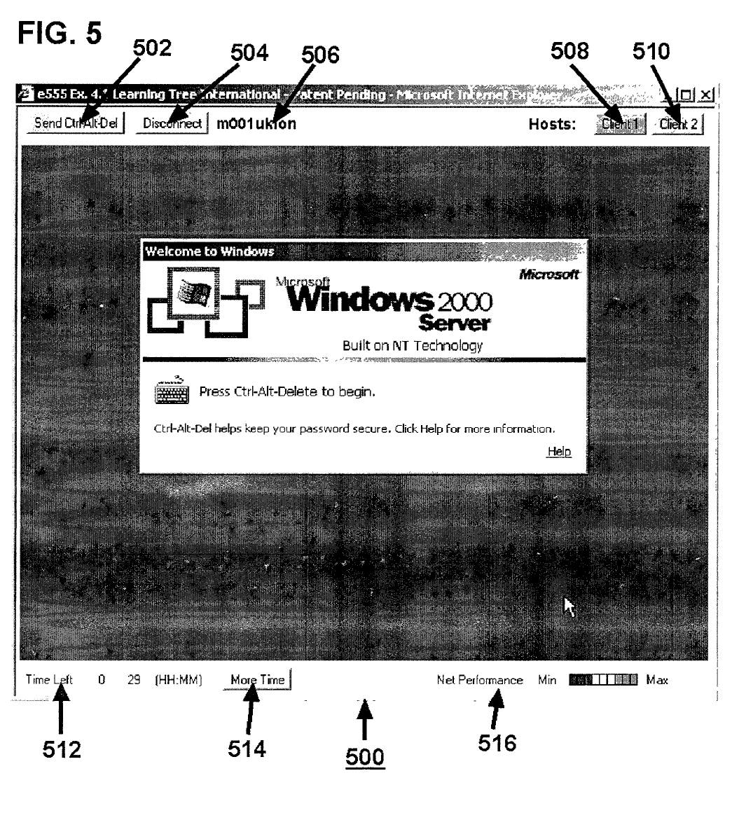

FIG. 5 is an exemplary screen shot 500 which illustrates a web page that is generated for the user after the redirection. This particular example is a Windows 2000 system that provides control button 502 for sending a CTRL-ALT-DEL sequence, button 504 to disconnect, and buttons 508-510 to toggle the display between different virtual machines. The machine name 506 of the presently active virtual machine (all are running but one is active) is displayed at the top of the screen.

In an embodiment where the exercise is timed, a remaining time 512 is displayed in the bottom left corner. Provisions can be made, such as button 514, to allow a client 202 to request more time. In a preferred embodiment, a net performance meter 516 is displayed. By timing the period it takes to receive instructions from the client 202, the DLM 208 can provide some indication of the network performance between the client 202 and the training network 220. Using this information, a client 202 can judge where a bottleneck is if the performance of the client's browser appears sluggish.

Finally in step 420, a client 220 either disconnects or runs out of time. Either of these events are detected by the DLM 208 which instructs the DLU to close down all virtual machines associated with the current training session and to clear itself by removing all temporary files in preparation for a fresh connection.

### Details of the DLU

The DLUs 210-214 are the workhorse machines of the training network 220. These machines are preferably powerful machines capable of running multiple Windows 2000 or Linux virtual machines 302-306. Exemplary hardware could include a machine similar in capability to dual Pentium III systems. The DLUs 210-214 connect to the physical network 222 so that a client machine 202 can access any combination of the plural virtual machines 302-306 via the Internet 204 or other network.

One method for providing multiple virtual machines 302-306 on a DLU is by using software similar to that provided by VMWare™. Other functionally equivalent software, however, is contemplated within the scope of the present training network 220. Using VMWare™, a script can be used to launch multiple virtual machines using a stored image of an operating environment. The virtual machines 302-306 that are launched on the DLU include virtualized network functionality such that they form a virtual network 308 amongst themselves to provide a virtual environment that simulates networked machines.

One preferred method for providing communication between the virtual machines 302-306 and the client 202 is via software such as VNC (Virtual Network Computing) available from AT&T Laboratories. This software facilitates a remote desktop within the client's Internet browser using a JAVA™ client downloaded when the connection between the client's browser and a virtual machine within the DLU is first established. In this manner, a single browser window provides an interface to plural virtual machines that comprise a virtual network in a virtual environment.

A port proxy, which can run on the DLU, translates requests from the virtual networks 308 that the virtual machines 302-306 use to the real network 222 that exists outside the DLU. The proxy also forwards data to the firewall 206 and then through the Internet 204 to the client machine 202.

Various embodiments of the DLU can use different hardware platforms, virtual computer software similar to VMWare™ or remote access software similar to VNC. For example, the DLUs 210-214 can utilize Linux as their host operating system or Windows 2000 or NT.

In a preferred embodiment, DLU software, in addition to the host operating system, the VNC package, and VMWare, includes a script controller program and the VNC proxy package. The proxy package can be the redir package described earlier, for example, or other software providing similar functionality. The controller program can be a Perl or other script program, or may even be an compiled executable program. In practice, the controller program communicates with the DLM to start/stop virtual machines and to report the status of the virtual machines on the DLU.

An exemplary set of requests and functions performed by the controller program can include:

STAT—Report status of virtual machines (VMs). In particular, the DLU reports whether or not it is busy, and if so, how many virtual machines are currently running. In one embodiment, the script can detect whether or not there are VMs running, in addition to, those the script itself started. That means that restarting the script (typically an unlikely event) should not cause incorrect STAT responses.

START—Start a virtual machine or machines. This command is sent by the DLM if the DLU has reported that it is free and the DLM has selected the DLU for work. A database can be used to determine what virtual machine images are started. That database can be a flat data file but a more sophisticated database (such as MySQL) can alternatively be employed.

STOP—Stop VMs. This is currently sent by the DLM after a pre-selected timeout (the timeout can be, for example, specified on the Web page from which the student selected the exercise) or by direct command through a DLM GUI that monitors activity.

The DLU can also send out messages, for example, The DLU can report its status as a broadcast (to support multiple DLMs) every n seconds. The DLM can also ask the DLUs for status every m seconds in order for the DLUs to be alerted to send their status. The message contains the DLU name (i.e., unique identifier), number of VMs running on the DLU, and their status (e.g., free, busy, down). In various embodiments, the DLU can also, or alternatively, send out one or more messages including information about the DLU's features (e.g., number of CPUs and processor speeds) so that the DLM can choose the DLU and/or CPU best suited for a particular task during a session (e.g., for an exercise).

### Exemplary DLM Operation

The DLM 208 is the controller of the DLUs 210-214. The DLM 208 receives requests from a web form or other user interface, searches for a DLU that has remaining capacity sufficient to run the requested session, and instructs the selected DLU to start an appropriate virtual environment. Additionally, the DLM 208 either informs the web server 208 to redirect the client 202 to a selected DLU or to notify the client 202 that no DLUs are available. This functionality can be accomplished using a scripting routine or a executable application.

Similar to the functionality described with regard to the DLUs, the DLM 208 can implement a simple communication protocol with DLUs comprising functions such as:

| Message | From | To | Port | Meaning |
|---|---|---|---|---|
| START | DLM | DLU | 4567 | Start specified VM |
| STOP | DLM | DLU | 4567 | Stop specified VM |
| SEND | DLM | DLU | 4567 | Send status of DLU to DLM |
| Status | DLU | DLM | 4568 | Response to SEND |
| NEWVM | WWW | DLM | 4569 | Request to start VM |
| OK | DLM | WWW | 4570 | Positive response to NEWVM |
| NO | DLM | WWW | 4570 | Negative response to NEWVM |

In one embodiment, the DLM 208 can broadcast a request, at regular intervals (i.e., every n seconds), to all DLUs 210-214 on the network 222 so that the DLUs can reply with a status message. The DLM 208 maintains a database of the status of the DLUs 210-214 and any DLU not heard from in a specified time period has its state changed to “down” and will not be asked to host any new virtual machines until it is heard from again. Additionally, the database maintained by the DLM 208 can include, in some embodiments, the capabilities of the DLUs based on their suitability to host one or more of the exercises that a client 202 can request.

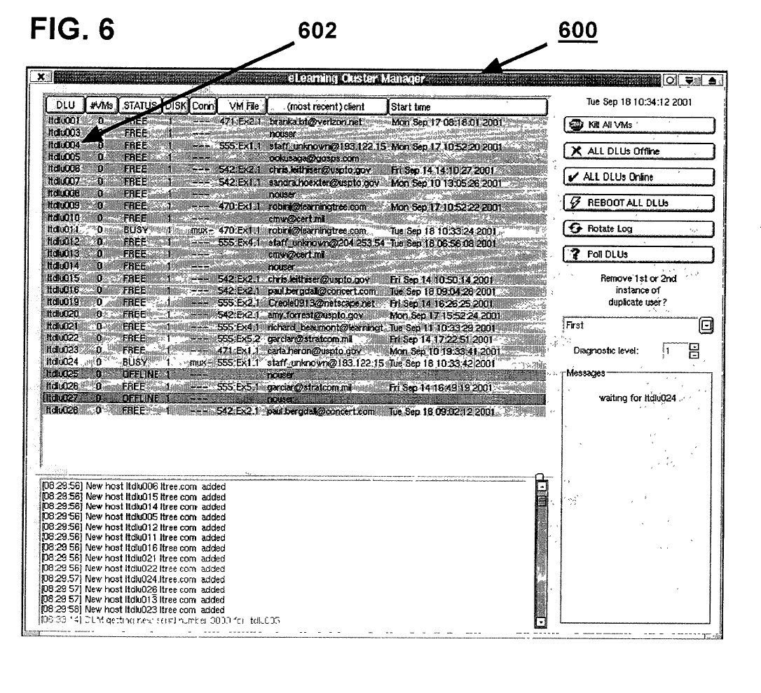

FIG. 6 illustrates an exemplary screen shot of a DLM that could be used by an administrator of the training network 220. In the top window 602 of the screen 600, the status of the various DLUs are displayed.

One benefit of the just-described arrangement of the DLM 208 is that the DLM contains no state information except for the last time a DLU was heard from; thus, it is not catastrophic to the training network 220 if the DLM 208 fails. A replacement or restarted system will recover its state from the information eventually received from the DLUs 210-214. While not explicitly depicted in any of the figures, the present invention contemplates a DLM receiving requests from more than one web server as well as the case in which plural DLMs cooperatively manage a network of DLUs.

### The Disk Servers

The disk servers 216-218 provide a storage solution and single point of reference for any virtual machine which is started. Preferably, each virtual machine is launched directly from a disk server using appropriate software such as from VMWare as described earlier. The request from the DLM 208 to a DLU to launch a virtual environment includes enough information to identify the operating environment, configuration and parameters of the virtual machines used in that particular training session. This operating environment includes the virtual machine's operating system, available software applications, available hardware configurations and current network settings.

In the instance in which a client 202 has available a number of different training sessions each having their own particular environments for different virtual machines, it becomes prohibitive (in terms of space and management) to store all the different possible operating environments on each DLU. Furthermore, storing the environments on the DLU may increase the chances that the information could be corrupted during a training exercise.

Therefore, in a preferred embodiment, the necessary configuration information for the different operating environments associated with each exercise or training session are stored in read-only mode on centrally located disk servers 216-218. When a DLU starts each virtual machine in response to being instructed by the DLM 208, that virtual machine loads its appropriate operating environment from a disk server instead of the local disk storage.

In practice, different training session are typically closely related to one another and use a similar operating environment for each exercise that might differ between exercises in only some minor way. In such an exemplary environment, the disk servers 216-218 would not need to store the full operating environments for each possible training session. Instead, the disk servers 216 218 can store a “base” operating environment and merely store the changes introduced by each training session in a progression of related training sessions. In this embodiment, when a virtual machine is launched for a training session that builds on environment modifications performed during earlier training sessions, the virtual machine need only load the base operating environment and the appropriate changes from the antecedent training sessions. Thus, storage requirements on the disk servers 216-218 can be reduced.

In one embodiment, a client's operating environment can be snap-shotted, much like a power-saving feature of a portable laptop saves the configuration of the laptop before going into power saving mode. As a result, a client 202 could save the results during the middle of a training session and return to an exercise in progress at some later time. In this embodiment, of course, the disk servers 216-218 would be configured to store client data in a manner that could be identified by the DLM 208 in order to correctly identify a returning user and their saved work product.

### SUMMARY

The present methods, apparatus, and systems provide instruction to one or more users at the same or different times in an interactive manner that provides actual responses to the actual user inputs during instruction. With the method, apparatus, and mechanism of the present invention, the user computer and additional networked computers typically cannot be crashed by the user inputs. Further, the present invention can provide online interactive instruction with high response speeds that substantially match speeds that would occur if a single user were providing instructions to computers, which they alone were accessing. Moreover, the present invention is scaleable in two dimensions (e.g., multiple physical machines, and multiple virtual networks per physical machine), providing substantial flexibility and maintaining speeds and availability for increasing numbers of concurrent users, while minimizing the amount of computer hardware, real estate, and power needed. The range of scalability is affected by the desired speed of virtual network operation, the amount of Internet or network connection bandwidth available and the logistics of housing a large server farm.

The systems, apparatus, and methods of the present invention have many advantages over previous systems, specifically in that a network environment can be created with, for example, Windows 2000 machines, Windows NT4.0, Windows 9X, or Linux machines, depending upon the resources required. Within this network, the users can do remotely whatever they like to any of the virtual machines, knowing that it is only a mock environment on which they are working. Once their session has finished, all the changes they made are currently discarded; or alternatively, this could be changed to save the system configuration, if they had not completed the exercise. The system is then cleaned up and the resources are ready for the next session. Therefore there is no danger of irrevocable major mistakes and many of the consequences of these mistakes can be witnessed (e.g., the physical machines do not need to be taken off line, fixed, and returned to operation).

A further benefit, as highlighted before, is that users get to control one or more actual computers. This means that they can use their own preferred methods for performing known tasks instead of having to follow a set route laid down by a training developer.

This remote-learning system can facilitate the next generation of computer-based learning environments, as well as other remote training, demonstration and sales applications. In addition, this system can be used and is configured to test software applications across multiple operating systems, all from a single client computer, simultaneously, over the Internet or other network with any operating system on the client computer.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

We claim:

1. A method for providing remote access to a software application comprising the steps of:
receiving an instruction at a host computer to communicate with a remotely located client computer;
in response to the instruction, initiating a plurality of virtual machines on the host computer;
receiving input from the client computer, said input addressed to a particular one of the virtual machines;
executing a software application on the particular virtual machine in accordance with the input; and
providing to the client computer any results from executing the software application in accordance with the input.

2. The method according to claim 1, wherein the step of initiating one or more virtual machines includes the steps of:
retrieving respective configuration parameters for each of the virtual machines; and
configuring the virtual machines according to the retrieved respective configuration parameters.

3. The method according to claim 2, wherein the step of retrieving the respective configuration parameters includes the steps of:
sending a request for respective configuration information based on the instruction, wherein the request is sent to a computer separate from the host computer; and
receiving the respective configuration information from the separate computer.

4. The method according to claim 1, further comprising the step of:
configuring each of the virtual machines to simulate a different computer on a network, such that the virtual machines are thereby organized as a virtual network.

5. The method according to claim 4, further comprising the steps of:
modifying configuration settings of the particular virtual machine based on the input;
operating the particular virtual machine according to the modified settings; and
providing to the client computer any output that results from the particular virtual machine operating according to the modified settings.

6. The method according to claim 1, further comprising the step of:
providing a user interface to the client computer, said user interface configured for display on a web browser and configured to accept the input and forward the input to the host computer.

7. The method according to claim 6, further comprising the steps of:
sending a Java client to the client computer, wherein said Java client implements on the client computer a remote desktop for the particular virtual machine.

8. The method according to claim 6, further comprising the step of:
providing in the user interface a respective, selectable icon corresponding to each virtual machine.

9. A method of providing remote computer based training from a host computer comprising the steps of:
communicating with a remotely located computer via a physical network;
executing a plurality of virtual machines on the host computer;
configuring each of the virtual machines to simulate a different host on a computer network, thereby organizing the virtual machines into a virtual network;
receiving input from the remotely located client computer, said input including instructions for operating a particular one of the virtual machines;
operating the particular one of the virtual machines according to the input; and
forwarding to the remotely located client computer actual results of operating the particular virtual machine according to the input to provide the remotely located client with an indication of how the particular virtual machine operates as a result of receiving the input.

10. The method according to claim 9, further comprising the steps of:
launching an operating environment on the particular virtual machine;
receiving data from the remotely located client computer;
operating a software application within the operating environment according to the received data; and
forwarding to the remotely located client computer actual results of operating the software application based on the received data.

11. The method according to claim 9, further comprising the steps of:
retrieving respective configuration settings for each virtual machine from a read-only storage repository located separate from the host computer; and
configuring each of the virtual machines according to the respective configuration settings.

12. A method for controlling remote access to a plurality of host systems comprising the steps of:
receiving a request from a client to access one of the host systems;
determining if any of the hosts systems are available to handle the request;
if a particular host system is available, commanding the particular host system to initiate a plurality of virtual machines; and
transmitting to the client the identity of the particular host.

13. The method according to claim 12, further comprising the step of:
if none of the host systems are available, informing the client that all host systems are busy.

14. The method according to claim 12, further comprising the step of:
receiving from each of the host systems a respective message, said message indicating an operating status of the respective host system.

15. The method according to claim 14, wherein the respective messages are received periodically.

16. The method according to claim 14, further comprising the step of:
querying each host system regarding their operating status, wherein the respective messages are received in response to the querying.

17. The method according to claim 12, further comprising the steps of:
maintaining a database of operating capabilities of each host system;
determining one or more appropriate host systems based on the request and operating capabilities; and
determining if any of the one or more appropriate hosts systems are available to handle the request.

18. The method according to claim 12, further comprising the steps of:
maintaining a timer based on when the particular host system is commanded to initiate the plurality of virtual machines; and
commanding the particular host system to terminate the plurality of virtual machines when the timer reaches a predetermined threshold.

19. A computer system providing remote access comprising:
(a) a first programmable computer comprising a first network interface configured for communicating with a remotely located client computer and a plurality of host computers, said first computer operating under control of a first software application so as to be configured to:
(1) identify an available one of the host computers based on a first request received from the client computer,
(2) forward the identity of the available host computer to the client computer via the first network interface, and
(3) transmit via the first network interface a command to the available host computer about the request; and
(b) a plurality of host computers, each comprising a second network interface configured to communicate with the first computer and the remotely located client computer; each host computer operating under control of a respective second software application so as to be configured to:
(1) initiate a plurality of virtual machines upon receiving a command from the first computer;
(2) receive data via the second network interface from the client computer;
(3) operate one or more of the virtual machines according to the received data; and
(4) forward, to the client computer via the second network interface, any output from the one or more virtual machines resulting from operating in accordance with the received data.

20. The system according to claim 19, wherein the first computer further comprises a first memory storing respective operating capabilities of each host computer, and the first computer is further configured to identify the available one of the host computers based on the request received from the client computer and the stored operating capabilities.

21. The system according to claim 19, further comprising:
(c) a particular one of the host computers further configured to send a second request via the second network interface to a second computer before initiating the plurality of virtual machines;
(d) the second computer comprising a third network interface configured for communicating with the host computers, and a first memory storing a plurality of sets of virtual machine configuration settings; said second computer operating under control of a third software application so as to be configured to:
(1) receive, via the third network interface, the second request from the particular host computer,
(2) search the second memory for one or more specific sets of settings based on the request, and
(3) forward the one or more specific sets of settings to the particular host computer via the third network interface; and
wherein the particular host computer uses the specific sets of settings when initiating the plurality of virtual machines upon receiving a command from the first computer.

22. A method for providing remote access to computer resources comprising the steps of:
receiving at a first computer a request from a remotely located second computer to use a third computer from among a plurality of host computers;
determining if the third computer is available for use by the second computer;
if the third computer is available, then sending:
a command from the first computer to the third computer to launch a plurality of virtual machines on the third computer, and
an identification of the third computer to the second computer;
if the third computer is not available, then informing the second computer that the third computer is not available;
in response to receiving the command, launching on the third computer the plurality of virtual machines;
receiving, at the third computer, input from the second computer;
operating the plurality of virtual machines according to the received input; and
forwarding, from the third computer to the second computer, the actual results of operating the plurality of virtual machines according to the received inputs.

23. The method according to claim 22, further comprising the steps of:
authenticating at the first computer the identity of the second computer; and
verifying that the second computer has permission to access the third computer.

24. The method according to claim 22, further comprising the steps of:
maintaining at the first computer a database of the host computers' respective capabilities; and
identifying the third computer based on its capabilities and the received request.

25. The method according to claim 22, further comprising the steps of:
storing at a fourth computer sets of configuration settings, each set defining the configuration of a virtual machine;
determining, at the fourth computer, particular sets of settings based on the received request;
transmitting the particular sets of settings from the fourth computer to the third computer; and
configuring the virtual machines according to the particular sets of settings.

26. The method according to claim 22, further comprising the step of:
sending a command to the third computer to terminate the virtual machines a predetermined time after receiving the request.
